(19) United States
(12) Patent Application Publication
(10) Pub. No.: US 2021/0185367 A1
(43) Pub. Date: Jun. 17, 2021

(54) Multimedia content playback device and multimedia content playback method

(71) Applicant: REALTEK SEMICONDUCTOR CORPORATION, HSINCHU (TW)

(72) Inventor: CHUNG-HSIEN WU, Hsinchu City (TW)

(21) Appl. No.: 17/117,209

(22) Filed: Dec. 10, 2020

(30) Foreign Application Priority Data
Dec. 17, 2019 (TW) 108146113

(51) Int. Cl. H04N 21/2387; H04N 21/231; H04N 21/2343

(52) U.S. Cl. CPC H04N 21/2387; H04N 21/23113; H04N 21/234345; H04N 21/23106

(57) ABSTRACT

A multimedia content playback device and a multimedia content playback method are provided. The multimedia content playback method includes the following steps: downloading a plurality of samples of a multimedia content to a memory via a network to obtain a plurality of downloaded samples, each sample having a time stamp; receiving a seek command that specifies a target start time; deleting one or more of the downloaded samples; and downloading a target sample corresponding to the target start time.

### BACKGROUND OF THE INVENTION

### 1. Field of the Invention

The present invention generally relates to the playback of multimedia contents, and, more particularly, to a multimedia content playback method and a multimedia content playback device that download multimedia contents through the network and play the multimedia contents.

### 2. Description of Related Art

FIG. 1 is an illustrative diagram of the downloads of the multimedia content according to the prior art. The multimedia content can be video, audio or a combination of both. The horizontal axis of FIG. 1 is time, where “0” represents the beginning of the multimedia content, and “END” represents the end of the multimedia content. The figure shows three segments that are enqueued or buffered (hereafter referred to as “enqueued segments”): S1, S2 and S3. The start time and end time of the enqueued segment S1 are t1 and t2, respectively, and the duration of the enqueued segment S1 is D1. The start time and end time of the enqueued segment S2 are t3 and t4, respectively, and the duration of the enqueued segment S2 is D2. The start time and end time of the enqueued segment S3 are t5 and t6, respectively, and the duration of the enqueued segment S3 is D3. Each enqueued segment contains multiple consecutive downloaded samples, and each sample has a time stamp. Taking the enqueued segment S1 as an example, the time stamp of the first sample of the enqueued segment S1 is t1, the time stamp of the last sample of the enqueued segment S1 is t2, and the difference between t2 and t1 is the duration D1. A sample can refer to a decodable unit of the multimedia content. For example, for video data, a sample can be a video frame; for audio data, a sample can be an audio frame. In cases where the samples are video frames, for a multimedia content with a frame rate of Fr (frames per second), the enqueued segment S1 contains Fr*(t2-t1) consecutive samples, the enqueued segment S2 contains Fr*(t4-t3) consecutive samples, and the enqueued segment S3 contains Fr*(t6-t5) consecutive samples.

When the user seeks to play the multimedia content (including seek forward and seek backward), the conventional multimedia playback device (such as a computer, a tablet, a mobile phone, a TV, a set-top box, etc.) searches the enqueued segments for the target sample (i.e., the sample corresponding to the target start time that the seek command specifies), deletes the target sample after finding it, and downloads the target sample again. The search process involves comparing the target start time with the time stamps. Since a specific sample (i.e., the target sample) must be found, the search action is quite time-consuming. As the number of downloaded samples increases, the user experience becomes poorer after the seek operation.

### SUMMARY OF THE INVENTION

In view of the issues of the prior art, an object of the present invention is to provide a multimedia content playback device and a multimedia content playback method, so as to improve device performance and user experience.

A multimedia content playback method is provided. The method includes the following steps: obtaining a plurality of downloaded samples by downloading via a network a plurality of samples of a multimedia content to a memory, wherein each sample has a time stamp; receiving a seek command which specifies a target start time; deleting one or more of the downloaded samples; and downloading a target sample corresponding to the target start time.

A multimedia content playback method is provided. The method includes the following steps: obtaining a plurality of downloaded samples by downloading via a network a plurality of samples of a multimedia content to a memory, wherein each sample has a time stamp; receiving a seek command which specifies a target start time; comparing the target start time with at least one of the time stamps; and downloading the first sample that is later than the target start time and not downloaded rather than downloading the sample corresponding to the target start time, when the memory stores the sample corresponding to the target start time.

A multimedia content playback device is provided. The multimedia content playback device includes a network transceiver circuit, a memory and a processing unit. The memory stores a plurality of program instructions or program codes. The processing unit, which is coupled to the network transceiver circuit and the memory, is configured to execute the program instructions or program codes to perform the following actions: obtaining a plurality of downloaded samples by using the network transceiver circuit to download a plurality of samples of a multimedia content to the memory, wherein each sample has a time stamp; receiving a seek command which specifies a target start time; deleting one or more of the downloaded samples; and downloading a target sample corresponding to the target start time to the memory.

A multimedia content playback device is provided. The multimedia content playback device includes a network transceiver circuit, a memory and a processing unit. The memory stores a plurality of program instructions or program codes. The processing unit, which is coupled to the network transceiver circuit and the memory, is configured to execute the program instructions or program codes to perform the following actions: obtaining a plurality of downloaded samples by using the network transceiver circuit to download a plurality of samples of a multimedia content to the memory, wherein each sample has a time stamp; receiving a seek command which specifies a target start time; comparing the target start time with at least one of the time stamps; and downloading the first sample that is later than the target start time and not downloaded rather than downloading the sample corresponding to the target start time, when the memory stores the sample corresponding to the target start time.

By reducing the comparison time and/or the number of comparisons after the seek operation, or reusing the downloaded data, the multimedia content playback device and the multimedia content playback method of the present invention provide smooth playback after the seek operation. In comparison with the conventional technology, the present invention provides a better user experience.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 is an illustrative diagram of the downloads of the multimedia content according to the prior art.

FIG. 2 is a functional block diagram of a portion of the multimedia playback device.

FIG. 3 is an illustrative storage content of the memory.

FIG. 4 is a flowchart of the multimedia content playback method according to an embodiment of the present invention.

FIG. 5 is a flowchart of the multimedia content playback method according to another embodiment of the present invention.

FIG. 6 is a flowchart of the multimedia content playback method according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a multimedia content playback device and a multimedia content playback method. On account of that some or all elements of multimedia content playback device could be known, the detail of such elements is omitted provided that such detail has little to do with the features of this disclosure, and that this omission nowhere dissatisfies the specification and enablement requirements. Some or all of the processes of the multimedia content playback method may be implemented by software and/or firmware, and can be performed by the multimedia content playback device or its equivalent. A person having ordinary skill in the art can choose components or steps equivalent to those described in this specification to carry out the present invention, which means that the scope of this invention is not limited to the embodiments in the specification.

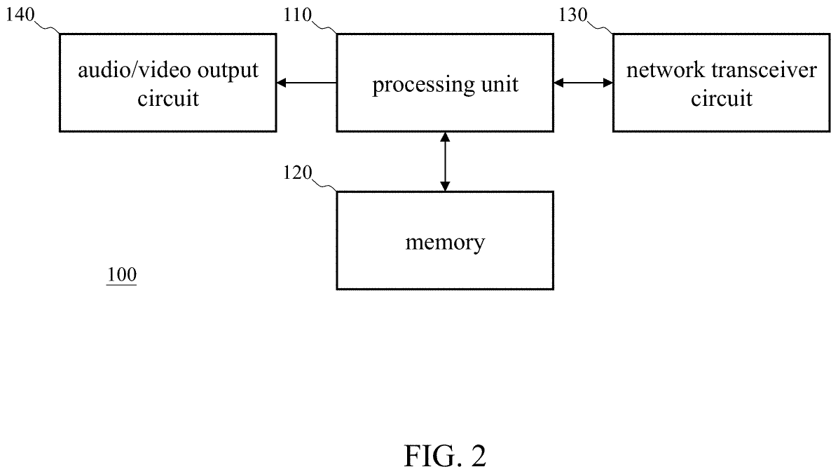

This disclosure relates to a multimedia content playback method that can be executed by a multimedia playback device (such as a computer, a tablet, a mobile phone, a TV, a set-top box, etc.). FIG. 2 is a functional block diagram of a portion of the multimedia playback device. The multimedia playback device 100 includes a processing unit 110, a memory 120, a network transceiver circuit 130 and an audio/video output circuit 140. The processing unit 110 may be a circuit or electronic component with program execution capability, such as a central processing unit (CPU), a microprocessor or a micro processing unit. The processing unit 110 realizes the functions of the multimedia playback device 100 by executing program codes or program instructions stored in the memory 120. The multimedia playback device 100 uses the network transceiver circuit 130 to download multimedia contents. The network transceiver circuit 130 can receive and transmit data through a wired and/or wireless network. The processing unit 110 plays the multimedia contents through the audio/video output circuit 140, which can be, for example, a display panel and/or a speaker, or a signal transmission interface (such as a High Definition Multimedia Interface (HDMI)).

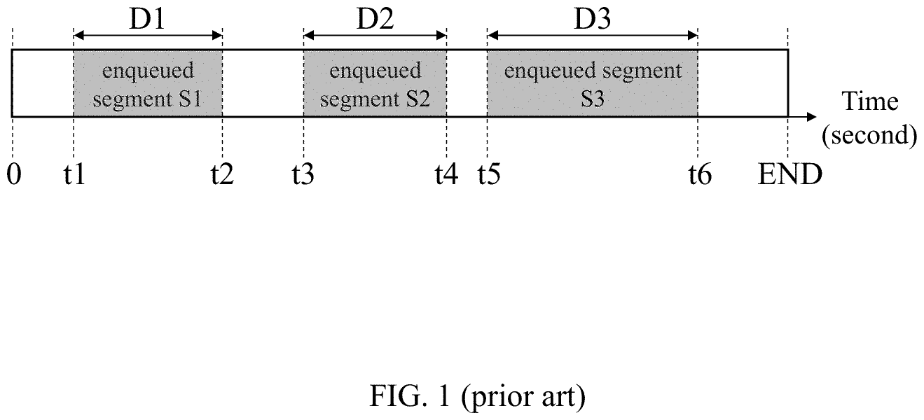

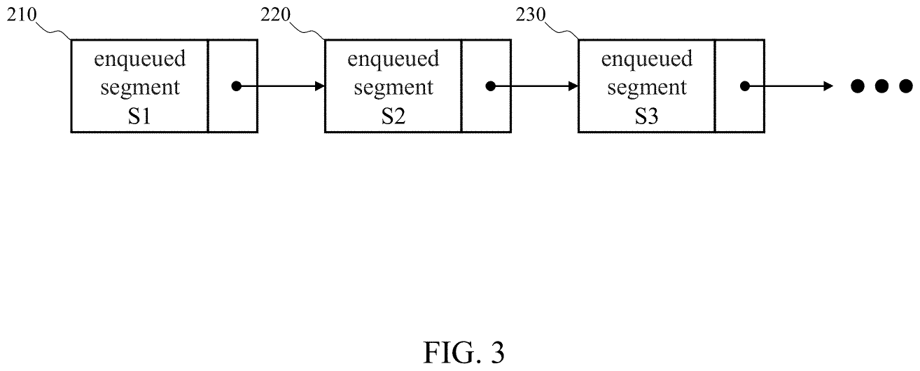

FIG. 3 is an illustrative storage content of the memory 120. The processing unit 110 may store the enqueued segments in the memory 120 in the form of a linked list. FIG. 3 shows that the linked list has three nodes: the node 210, the node 220 and the node 230. For example, the data of the node 210 may be the enqueued segment S1 in FIG. 1, the data of the node 220 may be the enqueued segment S2, and the data of the node 230 may be the enqueued segment S3. The addresses of the node 210, the node 220, and the node 230 in the memory 120 may be continuous or not. After visiting a node, the processing unit 110 can obtain the start time, the end time and/or the duration of the enqueued segment corresponding to the node. Since the linked list is well known to people having ordinary skill in the art, its details are omitted herein for brevity.

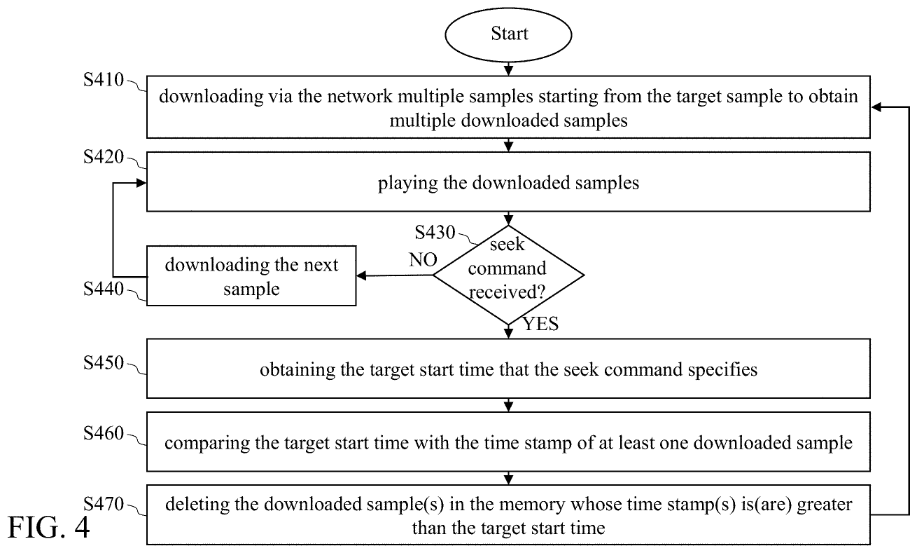

FIG. 4 is a flowchart of the multimedia content playback method according to an embodiment of the present invention. The processing unit 110 uses the network transceiver circuit 130 to download via the network multiple samples starting from the target sample; as a result, the processing unit 110 obtains multiple downloaded samples which are stored in the memory 120 (step S410). Next, the processing unit 110 plays the downloaded samples starting from a target start time via the audio/video output circuit 140 (step S420). When the user does not specify the target start time (e.g., playing the multimedia content from the beginning), the default target start time is the 0^{th} second, and thus the target sample is the first sample of the multimedia content. Next, the processing unit 110 determines whether a seek command is received (step S430). If no seek command is received, the processing unit 110 proceeds to download the next sample (i.e., continuously downloading the samples in chronological order) (step S440), and then continues to play the downloaded samples in chronological order (step S420).

The seek command is, for example, an application programming interface (API) used to specify the target start time (such as the command “SeekTo:” or a command or function having the same purpose or effect). The target start time is a time point of the multimedia content, which time point is of the user's interest. Typically, the application executed by the processing unit 110 calls the seek command in response to the user's operations, such as: scrolling the timeline scrollbar of the player, pressing the fast forward/rewind button, entering the target time, etc. Receipt of the seek command by the processing unit 110 means that the seek command has been called.

After receiving the seek command (YES branch of step S430), the processing unit 110 obtains the target start time that the seek command specifies (step S450). Next, the processing unit 110 compares the target start time with the time stamp of at least one downloaded sample (step S460), and then deletes the downloaded sample(s) (if any) in the memory 120 whose time stamp(s) is(are) greater than the target start time (step S470). After step S470 finishes, the processing unit 110 downloads multiple samples starting from the target sample, which is the sample corresponding to the target start time (step S410), and plays the downloaded samples starting from the target start time (step S420). The details of steps S460 and S470 are further discussed in the following through examples.

Reference is made to FIG. 1. In some embodiments, in step S460, the processing unit 110 compares the time stamps of the first samples of the enqueued segment S1, the enqueued segment S2 and the enqueued segment S3 in sequence with the target start time. In other words, when comparing the target start time with multiple consecutive samples, the processing unit 110 can simply compare the target start time with the first sample of the consecutive samples. If t1 is greater than the target start time (i.e., 0<target start time<t1), then the processing unit 110 only needs to perform the comparison once in step S460, and then deletes the enqueued segment S1, the enqueued segment S2 and the enqueued segment S3 in step S470. If, on the other hand, t1 is less than the target start time, the processing unit 110 continues to perform other comparisons (e.g., compare the target start time with t3 and/or t5). The purpose of steps S460 to S470 is to find samples in the memory 120 whose time stamp is greater than the target start time and delete these samples. In this way, the processing unit 110 does not need to spend a lot of time comparing the target start time with the time stamps (in some cases only one comparison is needed, for example, when 0<target start time<t1). As a result, the performance of the multimedia playback device 100 and user experience can be improved. This advantage becomes more obvious when there are a large number of enqueued segments accumulated in the memory 120.

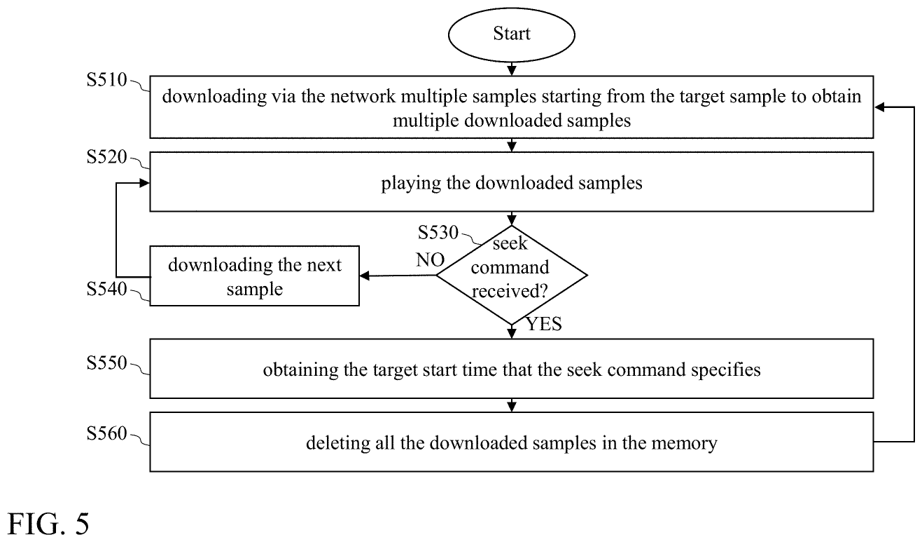

FIG. 5 is a flowchart of the multimedia content playback method according to another embodiment of the present invention. The flow of FIG. 5 is similar to that of FIG. 4 (steps S510 to S550 are the same as steps S410 to S450, respectively), except that in the embodiment of FIG. 5, the processing unit 110 deletes all the downloaded samples in the memory 120 (i.e., deleting all the enqueued segments in FIG. 3) after receiving the seek command (step S560), and then downloads and plays the multimedia content starting from the sample corresponding to the target start time. In other words, in this embodiment, the processing unit 110 does not compare the target start time and the time stamps. In this way, the performance of the multimedia playback device 100 can be further improved.

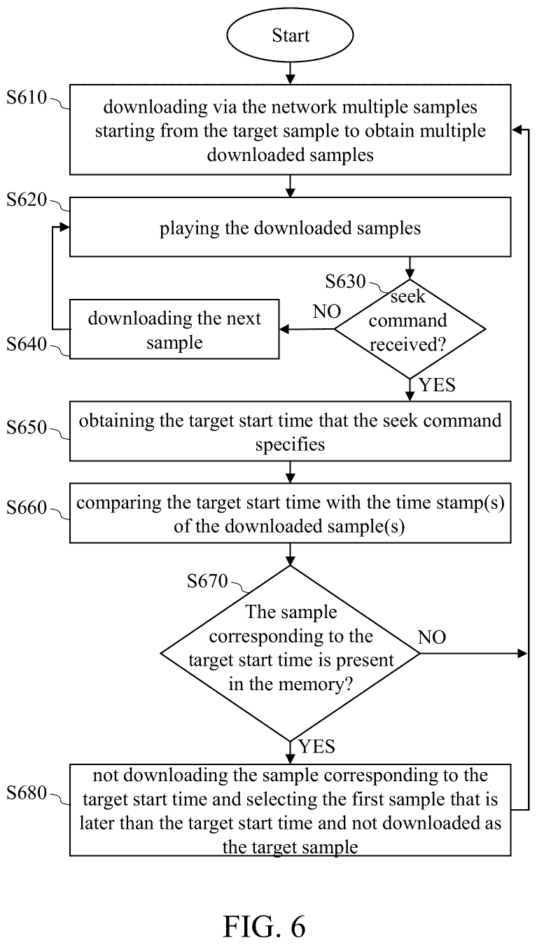

FIG. 6 is a flowchart of the multimedia content playback method according to another embodiment of the present invention. Steps S610 to S650 are the same as steps S410 to S450 respectively, and the details shall be omitted herein for brevity. After receiving the seek command (step S630) and obtaining the target start time that the seek command specifies (step S650), the processing unit 110 compares the target start time with the time stamp(s) of the downloaded sample(s) (step S660).

When all the downloaded samples in the memory 120 are not the sample corresponding to the target start time (NO branch of step S670), the processing unit 110 goes back to step S610 to download the target sample (i.e., the sample corresponding to the target start time), and then plays the multimedia content starting from the target start time.

When the memory 120 stores the downloaded sample corresponding to the target start time (YES branch of step S670), the processing unit 110 does not download the sample corresponding to the target start time, and selects the first sample that is later than the target start time and not downloaded (e.g., not stored in the memory 120) as the target sample (step S680). For example (reference is made to FIG. 1), when the target sample falls within the enqueued segment S2 (i.e., t3≤target start time≤t4), the processing unit 110 does not download the target sample, and sets or updates the target start time to be the sample that is right next to the enqueued segment S2 and not downloaded (i.e., the sample that immediately follows in time the sample corresponding to the time point t4). In other words, in step S680, the processing unit 110 selects the sample as the target sample, which sample is not downloaded and whose time stamp is greater than the target start time but the smallest.

After step S680 is finished, the processing unit 110 goes back to step S610 to download the target sample (i.e., the first sample that is later than the target start time and not downloaded), and then plays the multimedia content starting from the target start time in step S620.

In some embodiments, the processing unit 110 can promptly know the result of step S670 by simply comparing, in step S660, the target start time with the start time and the end time of the enqueued segment(s); as a result, the comparison time is reduced. Repeated downloads of samples can be avoided in the embodiment of FIG. 6, making the playback after the seek operation more smooth.

Since a person having ordinary skill in the art can appreciate the implementation detail and the modification thereto of the present method invention through the disclosure of the device invention, repeated and redundant description is thus omitted. Please note that there is no step sequence limitation for the method inventions as long as the execution of each step is applicable. Furthermore, the shape, size, and ratio of any element and the step sequence of any flowchart in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A multimedia content playback method, comprising:
obtaining a plurality of downloaded samples by downloading via a network a plurality of samples of a multimedia content to a memory, wherein each sample has a time stamp;
receiving a seek command which specifies a target start time;
deleting one or more of the downloaded samples; and
downloading a target sample corresponding to the target start time.

2. The method of claim 1, further comprising:
comparing the target start time with at least one of the time stamps;
wherein the step of deleting one or more of the downloaded samples deletes at least one downloaded sample whose time stamp is greater than the target start time.

3. The method of claim 1, wherein the step of deleting one or more of the downloaded samples deletes the downloaded samples.

4. A multimedia content playback method, comprising:
obtaining a plurality of downloaded samples by downloading via a network a plurality of samples of a multimedia content to a memory, wherein each sample has a time stamp;
receiving a seek command which specifies a target start time;
comparing the target start time with at least one of the time stamps; and
downloading the first sample that is later than the target start time and not downloaded rather than downloading the sample corresponding to the target start time, when the memory stores the sample corresponding to the target start time.

5. A multimedia content playback device, comprising:
a network transceiver circuit;
a memory, storing a plurality of program instructions or program codes; and
a processing unit, coupled to the network transceiver circuit and the memory and configured to execute the program instructions or program codes to perform following actions:
obtaining a plurality of downloaded samples by using the network transceiver circuit to download a plurality of samples of a multimedia content to the memory, wherein each sample has a time stamp;
receiving a seek command which specifies a target start time;
deleting one or more of the downloaded samples; and
downloading a target sample corresponding to the target start time to the memory.

6. The multimedia content playback device of claim 5, wherein the processing unit further performs following actions:
comparing the target start time with at least one of the time stamps;
wherein the step of deleting one or more of the downloaded samples deletes at least one downloaded sample whose time stamp is greater than the target start time.

7. The multimedia content playback device of claim 5, wherein the step of deleting one or more of the downloaded samples deletes the downloaded samples.
